(19) United States
(12) Patent Application Publication
(10) Pub. No.: US 2017/0341150 A1
(43) Pub. Date: Nov. 30, 2017

(54) INTERCHANGEABLE CUTTING INSERTS AND METHODS ASSOCIATED WITH THE SAME

(71) Applicant: ILLINOIS TOOL WORKS INC., Glenview, IL (US)

(72) Inventor: Jeremy E. Weinberg, Oak Park, IL (US)

(21) Appl. No.: 15/680,620

(22) Filed: Aug. 18, 2017

Related U.S. Application Data
(63) Continuation-in-part of application No. 14/527,141, filed on Oct. 29, 2014.

(51) Int. Cl. B23B 5/16; B23B 27/06

(52) U.S. Cl. CPC B23B 5/167; B23B 27/06; B23B 5/161; B23B 2210/02; B23B 2200/3627; B23B 2200/0447; B23B 2215/72; B23B 2220/28; B23B 2205/10

(57) ABSTRACT

In one aspect, a pipe cutting assembly is provided and includes a first base, a second base and a cutting insert. The first base includes a first projection and a first coupling aperture defined in the first projection. The second base is separate from the first base and includes a second projection and a second coupling aperture defined in the second projection. The cutting insert includes a cutting edge and an insert aperture defined therein. The cutting insert interchangeably couples to the first base and the second base. With the cutting insert coupled to the first base, the first projection is at least partially positioned in the insert aperture, and, with the cutting insert coupled to the second base, the second projection is at least partially positioned in the insert aperture. In one aspect, a pipe machining apparatus is provided and includes this pipe cutting assembly.

### RELATED APPLICATIONS

The present application is a continuation-in-part of co-pending U.S. Non-Provisional patent application Ser. No. 14/527,141, filed Oct. 29, 2014, which is incorporated by reference herein.

### FIELD OF THE INVENTION

The present disclosure generally relates to pipe machining apparatuses and cutting tools and, more particularly, to pipe machining apparatuses and cutting tools including cutting inserts.

### BACKGROUND

Pipe machining apparatuses are capable of machining objects, such as pipes, in a variety of different manners. In some manners, pipes are cut along a plane perpendicular to a longitudinal axis of the pipe, thereby provided a flat-cut end of the pipe. In other manners, pipes may be cut with a bevel along an axis or plane transverse to a longitudinal axis of the pipe. Pipe machining apparatuses may also include multiple cutting tools for cutting multiple bevels into a pipe. For example, when a pipe is cut, it is cut into two pieces. In such an example, the pipe machining apparatus may include a first cutting tool to bevel an end of the first cut piece of pipe and a second cutting tool to bevel an end of the second cut piece of pipe.

Pipe machining apparatuses may also be capable of cutting bevels into the ends of the pipe at multiple angles. Thus, a large variety of cutting tools are required to provide the variety of bevel cuts. A user would be required to keep track of the large variety of tools, which can be cumbersome and the possibility of losing one or more cutting tools is high. Moreover, due to the types of objects cut and the conditions in which the pipe machining apparatus operates, cutting tools must be made of durable and expensive material. Thus, such cutting tools are expensive. Expensive cutting tools combined with the requirement of maintaining large quantities of tools in order to perform the wide variety of bevel cuts results in an expensive endeavor. Additionally, losing and damaging cutting tools results in expensive replacement of the cutting tools.

### SUMMARY

Thus, a need exists for a cutting tool that resolves one or more of the above-referenced issues or other issues that exist with cutting objects.

The present disclosure is defined by the following claims, and nothing in this section should be taken as a limitation on those claims.

In one aspect, a cutting insert configured to be coupled to a pipe machining apparatus to cut a pipe is provided. The cutting insert includes a first cutting edge, a second cutting edge opposite the first cutting edge, a third edge extending between the first cutting edge and the second cutting edge, and a fourth edge opposite the third edge and extending between the first cutting edge and the second cutting edge.

In one aspect, the first cutting edge and the second cutting edge are generally parallel to each other.

In one aspect, the third edge and the fourth edge are generally parallel to each other.

In one aspect, the first cutting edge and the second cutting edge are not perpendicular to the third and fourth edges.

In one aspect, the cutting insert further includes a coupling aperture defined through the cutting insert.

In one aspect, the cutting insert is configured to be coupled to a base of a cutting tool in a first orientation, in which the first cutting edge is positioned to cut a pipe, and a second orientation, in which the second cutting edge is positioned to cut a pipe.

In one aspect, the third edge is configured to engage the base with the cutting insert in the first orientation and the fourth edge is configured to engage the base with the cutting insert in the second orientation.

In one aspect, a pipe cutting assembly is provided and includes a first base, a second base separate from the first base, and a cutting insert including a cutting edge configured to cut a pipe. The cutting insert interchangeably couples to the first base and the second base. The cutting insert is configured to perform a first cut with the cutting insert coupled to the first base and a second cut with the cutting insert coupled to the second base. The first cut is different than the second cut.

In one aspect, the first cut is a first bevel cut at a first angle and the second cut is a second bevel cut at a second angle different than the first angle.

In one aspect, the first angle is about 30 degrees and the second angle is about 37.5 degrees.

In one aspect, the first base includes a first coupling aperture, the second base includes a second coupling aperture and the cutting insert includes an insert aperture. The pipe cutting assembly further includes a coupling member interchangeably insertable into the insert aperture and the first coupling aperture when aligned to interchangeably couple the cutting insert to the first base, and the insert aperture and the second coupling aperture when aligned to interchangeably couple the cutting insert to the second base.

In one aspect, the first base includes a first lip and a first surface on the first lip. The second base includes a second lip and a second surface on the second lip. The cutting insert engages the first surface on the first lip when coupled to the first base and engages the second surface on the second lip when coupled to the second base.

In one aspect, the first surface extends at a first angle and the second surface extends at a second angle different than the first angle. The cutting edge is orientated at a first cutting angle with the cutting insert coupled to the first base and at a second cutting angle with the cutting insert coupled to the second base.

In one aspect, the cutting edge is a first cutting edge and the cutting insert further includes a second cutting edge.

In one aspect, the cutting insert is made of a first material and at least one of the first base and the second base is made of a second material different than the first material.

In one aspect, a pipe machining apparatus is provided and includes a frame, a tool carrier moveably coupled to the frame, a tool support coupled to and moveable with the tool carrier, a first cutting tool base configured to be coupled to the tool support, and a second cutting tool base configured to be coupled to the tool support. The first cutting tool base and the second cutting tool base are interchangeably coupled to the tool support. The pipe machining apparatus also includes a cutting insert interchangeably coupled to the first cutting tool base and the second cutting tool base. The cutting insert includes a cutting edge. The cutting insert is oriented in a first orientation to perform a first cut with the cutting insert coupled to the first cutting tool base and in a second orientation to perform a second cut with the cutting insert coupled to the second cutting tool base. The first cut is different than the second cut.

In one aspect, the first cut is a first bevel cut at a first angle and the second cut is a second bevel cut at a second angle different than the first angle.

In one aspect, the first angle is about 30 degrees and the second angle is about 37.5 degrees.

In one aspect, the first cutting tool base includes a first lip and a first surface on the first lip. The second cutting tool base includes a second lip and a second surface on the second lip. The cutting insert engages the first surface on the first lip when coupled to the first cutting tool base and engages the second surface on the second lip when coupled to the second cutting tool base.

In one aspect, the first surface extends at a first angle and the second surface extends at a second angle different than the first angle. The cutting edge is orientated at a first cutting angle with the cutting insert coupled to the first cutting tool base and at a second cutting angle with the cutting insert coupled to the second cutting tool base.

In one aspect, the cutting edge is a first cutting edge and the cutting insert further includes a second cutting edge.

In one aspect, the cutting insert is made of a first material and at least one of the first cutting tool base and the second cutting tool base is made of a second material different than the first material.

In one aspect, the first cutting tool base defines a first coupling aperture, the second cutting tool base defines a second coupling aperture, and the cutting insert defines an insert aperture. The pipe machining apparatus further includes a coupling member interchangeably insertable into the insert aperture and the first coupling aperture when aligned to interchangeably couple the cutting insert to the first cutting tool base and into the insert aperture and the second coupling aperture when aligned to interchangeably couple the cutting insert to the second cutting tool base.

In one aspect, a pipe cutting assembly is provided and includes a first base including a first projection and a first coupling aperture defined in the first projection. The pipe cutting assembly also includes a second base separate from the first base, and the second base includes a second projection and a second coupling aperture defined in the second projection. The pipe cutting assembly further includes a cutting insert including a cutting edge and an insert aperture defined therein. The cutting insert interchangeably couples to the first base and the second base. With the cutting insert coupled to the first base, the first projection is at least partially positioned in the insert aperture, and, with the cutting insert coupled to the second base, the second projection is at least partially positioned in the insert aperture.

In one aspect, the insert aperture may define a first portion having a first configuration and a second portion having a second configuration different than the first configuration. The first configuration may be complementary to configurations of the first and second projections.

In one aspect, the first projection and the second projection may have a same configuration.

In one aspect, with the cutting insert coupled to the first base, the first coupling aperture may align with the insert aperture, and, with the cutting insert coupled to the second base, the second coupling aperture may align with the insert aperture.

In one aspect, the pipe cutting assembly may further comprise a coupling member configured to insert into the aligned first coupling aperture and insert aperture with the cutting insert coupled to the first base and configured to insert into the aligned second coupling aperture and insert aperture with the cutting insert coupled to the second base.

In one aspect, the first projection may be one of a plurality of first projections on the first base and the second projection may be one of a plurality of second projections on the second base. The first coupling aperture may be one of a plurality of first coupling apertures defined in the first base and the second coupling aperture may be one of a plurality of second coupling apertures defined in the second base. One of the plurality of first coupling apertures may be defined in each of the plurality of first projections and one of the plurality of second coupling apertures may be defined in each of the plurality of second projections.

In one aspect, the insert aperture may be one of a plurality of insert apertures defined in the cutting insert, and, with the cutting insert coupled to the first base, one of the plurality of first projections may be at least partially positioned in each of the plurality of insert apertures, and, with the cutting insert coupled to the second base, one of the plurality of second projections may be at least partially positioned in each of the plurality of insert apertures.

In one aspect, the pipe cutting assembly may further comprise a plurality of coupling members. Each of the plurality of coupling members may be configured to insert into an aligned set of one of the first coupling apertures and one of the insert apertures with the cutting insert coupled to the first base and may be configured to insert into an aligned set of one of the second coupling apertures and one of the insert apertures with the cutting insert coupled to the second base.

In one aspect, a pipe machining apparatus is provided and includes a frame, a tool carrier moveably coupled to the frame, a tool support coupled to and moveable with the tool carrier, a first base including a first projection and a first coupling aperture defined in the first projection, and a second base separate from the first base. The second base includes a second projection and a second coupling aperture defined in the second projection. The tool support is configured to interchangeably support the first base and the second base. The pipe machining apparatus further includes a cutting insert including a cutting edge and an insert aperture defined therein. The cutting insert interchangeably couples to the first base and the second base, and, with the cutting insert coupled to the first base, the first projection is at least partially positioned in the insert aperture, and, with the cutting insert coupled to the second base, the second projection is at least partially positioned in the insert aperture.

In one aspect, the insert aperture may define a first portion having a first configuration and a second portion having a second configuration different than the first configuration. The first configuration may be complementary to configurations of the first and second projections.

In one aspect, the first projection and the second projection may have a same configuration.

In one aspect, with the cutting insert coupled to the first base, the first coupling aperture may align with the insert aperture, and, with the cutting insert coupled to the second base, the second coupling aperture may align with the insert aperture.

In one aspect, the pipe machining apparatus may further comprise a coupling member configured to insert into the aligned first coupling aperture and insert aperture with the cutting insert coupled to the first base and configured to insert into the aligned second coupling aperture and insert aperture with the cutting insert coupled to the second base.

In one aspect, the first projection may be one of a plurality of first projections on the first base and the second projection may be one of a plurality of second projections on the second base. The first coupling aperture may be one of a plurality of first coupling apertures defined in the first base and the second coupling aperture may be one of a plurality of second coupling apertures defined in the second base. One of the plurality of first coupling apertures may be defined in each of the plurality of first projections and one of the plurality of second coupling apertures may be defined in each of the plurality of second projections.

In one aspect, the insert aperture may be one of a plurality of insert apertures defined in the cutting insert, and, with the cutting insert coupled to the first base, one of the plurality of first projections may be at least partially positioned in each of the plurality of insert apertures, and, with the cutting insert coupled to the second base, one of the plurality of second projections may be at least partially positioned in each of the plurality of insert apertures.

In one aspect, the pipe machining apparatus may further comprise a plurality of coupling members. Each of the plurality of coupling members may be configured to insert into an aligned set of one of the first coupling apertures and one of the insert apertures with the cutting insert coupled to the first base and may be configured to insert into an aligned set of one of the second coupling apertures and one of the insert apertures with the cutting insert coupled to the second base.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a perspective view of one example of a pipe machining apparatus configured to cut an object, such as a pipe, and includes one example of cutting tools, according to one aspect of the present disclosure.

FIG. 2 is an enlarged perspective view of a portion of the pipe machining apparatus shown in FIG. 1 with examples of interchangeable cutting tools, according to one aspect of the present disclosure.

FIG. 3 is an elevational view of one example of cutting tools shown in solid and another example of cutting tools shown in dashed with the various cutting tools being interchangeable, according to one aspect of the present disclosure.

FIG. 4 is an elevational view of one example of a cutting tool configured to be included in the pipe machining apparatus shown in FIG. 1, according to one aspect of the present disclosure.

FIG. 5 is an elevational view of one example of a cutting tool configured to be included in the pipe machining apparatus shown in FIG. 1, according to one aspect of the present disclosure.

FIG. 6 is an exploded view of the cutting tools shown in FIGS. 4 and 5 with one example of an interchangeable cutting insert, according to one aspect of the present disclosure.

FIG. 7 is an elevational view of one example of a cutting tool configured to be included in the pipe machining apparatus shown in FIG. 1, according to one aspect of the present disclosure.

FIG. 8 is an elevational view of one example of a cutting tool configured to be included in the pipe machining apparatus shown in FIG. 1, according to one aspect of the present disclosure.

FIG. 9 is an exploded view of the cutting tools shown in FIGS. 7 and 8 with one example of an interchangeable cutting insert, according to one aspect of the present disclosure.

FIG. 10 is an exploded view of examples of cutting tools configured to be included in the pipe machining apparatus shown in FIG. 1, according to one aspect of the present disclosure.

FIG. 11 is a cross-sectional view taken along line 11-11 in FIG. 10, according to one aspect of the present disclosure.

FIG. 12 is an exploded view of examples of cutting tools configured to be included in the pipe machining apparatus shown in FIG. 1, according to one aspect of the present disclosure.

FIG. 13 is a cross-sectional view taken along line 13-13 in FIG. 12, according to one aspect of the present disclosure.

FIG. 14 is an exploded view of the examples of cutting tools shown in FIGS. 10 and 12 with one example of a spacer interchangeably and/or selectively coupled to the examples of the cutting tools, according to one aspect of the present disclosure.

FIG. 15 is an elevational view of one of the cutting tools and the spacer shown in FIG. 14 coupled to a tool support, according to one aspect of the present disclosure.

FIG. 16 is an elevational view of one of the cutting tools and the spacer shown in FIG. 14 coupled to the tool support, according to one aspect of the present disclosure.

### DETAILED DESCRIPTION

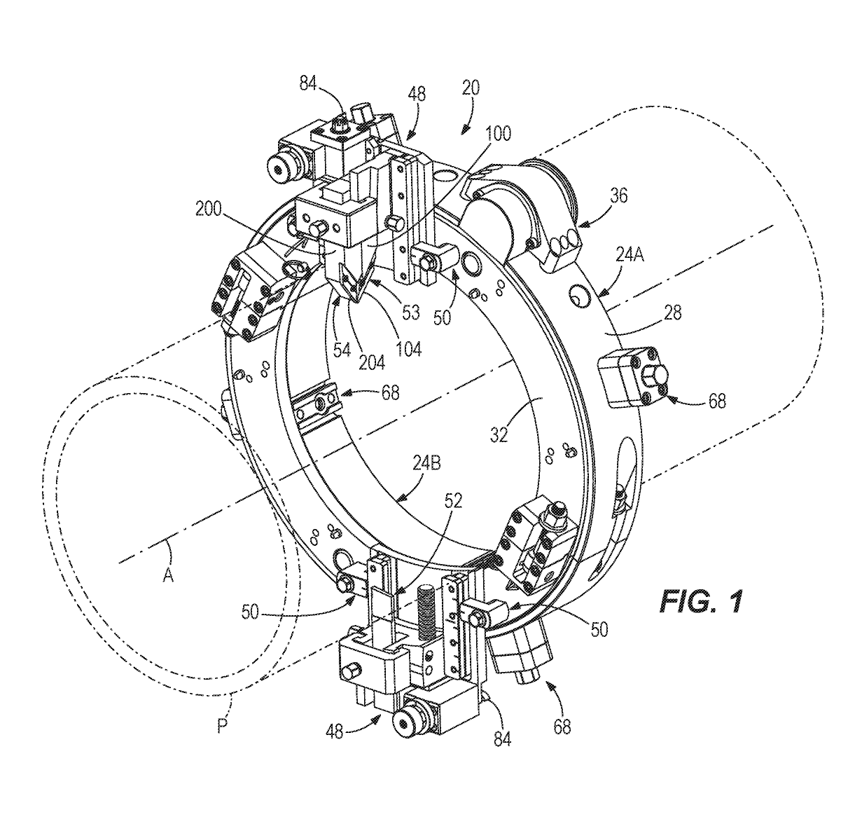

With reference to FIG. 1, there is shown one example of a pipe machining apparatus 20 configured to machine pipes P of varying diameters. In some examples, the apparatus 20 completely cuts through pipes P. In other examples, the apparatus 20 prepares an end of a pipe P for coupling to another pipe. In still other examples, the apparatus 20 both completely cuts and prepares a pipe P for coupling to another pipe. In these examples, cutting and/or preparing an end of a pipe P may result in a cut end of the pipe P being cut along a plane generally perpendicular to a longitudinal axis A of the pipe P or cut along a plane transverse to the longitudinal axis A of the pipe P. In some examples, cutting an end of the pipe P along a transverse plane may be referred to as a bevel cut and result in a beveled end of the pipe P. Beveled ends of a pipe may be cut along a wide variety of transverse planes and at a wide variety of angles relative to the longitudinal axis A of the pipe P. In some examples, the beveled ends may be cut along a plane that is traverse to the longitudinal axis A of the pipe at about a 30-degree angle. In other examples, the beveled ends may be cut along a plane that is traverse to the longitudinal axis A of the pipe at about a 37.5-degree angle. These examples of beveled ends, planes and angles are not intended to be limiting upon the present disclosure, but are rather provided to demonstrate at least some of the principles of the present disclosure.

In the illustrated example, the pipe machining apparatus 20 is formed of two joined-together semicircular sections 24A, 24B and includes a frame 28 and a tool carrier 32. The two sections 24A, 24B together comprise the frame 28 and the tool carrier 32 such that a first portion of the frame 28 and a first portion of the tool carrier 32 are included in one section 24A and a second portion of the frame 28 and a second portion of the tool carrier 32 are included in the other section 24B. In the illustrated example, the frame 28 has a column 36 extending outwardly of the two semicircular sections 24A, 24B and houses a pinion gear configured to couple with a suitable drive motor, such as, for example, an air motor, with suitable gear reduction means. The frame 28 is configured to couple and be fixed relative to a pipe P, and the tool carrier 32 is rotatable relative to the fixed frame 28 and the pipe P. The motor is configured to rotate the tool carrier 32 relative to the frame 28 through a gear train in the column 36.

The rotatable tool carrier 32 includes one or more tool supports 48 (two tool supports 48 shown in the illustrated example), which support tools 52, 53, 54 for performing cutting or machining operations on the pipe P as the tools 52, 53, 54 rotate circumferentially about the pipe P. The tool supports 48 are coupled to the tool carrier 32 by a plurality of coupling members 50. The machining operation performed by the tool 52 may form a straight edge generally perpendicular to a longitudinal axis A of the pipe P. The tools 53, 54 may form bevels on ends 56, 58 of the two cut pieces P1, P2 of the pipe P that are along planes 60, 62 transverse to the longitudinal axis A of the pipe P. The transverse planes 60, 62 may be at any angle relative to the longitudinal axis A of the pipe P other than ninety degrees. For purposes of demonstrating principles of the present disclosure, the transverse planes 60, 62 will be described as being at about 30 degrees from perpendicularity to the longitudinal axis A of the pipe P or at about 37.5 degrees from perpendicularity to the longitudinal axis A of the pipe P.

In the illustrated example, the apparatus 20 includes four adjustable clamp members or coupling members 68 engageable with an exterior of the pipe P and having suitable adjustability to couple and concentrically locate the apparatus 20 to the pipe P.

One or more projections may be adjustably movable into and out of a path of an advancement member 84 coupled to each tool support 48 to advance the tools 52, 53, 54 toward the pipe P. The apparatus 20 may include any number of projections for engaging advancement members 84.

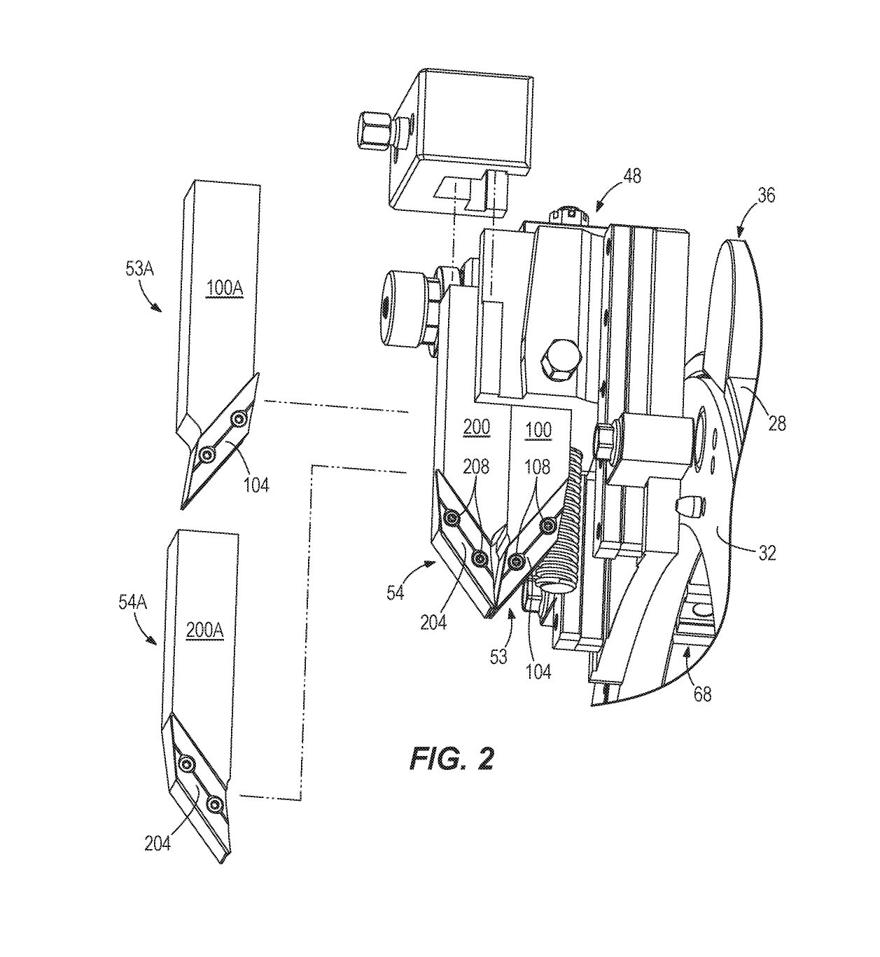

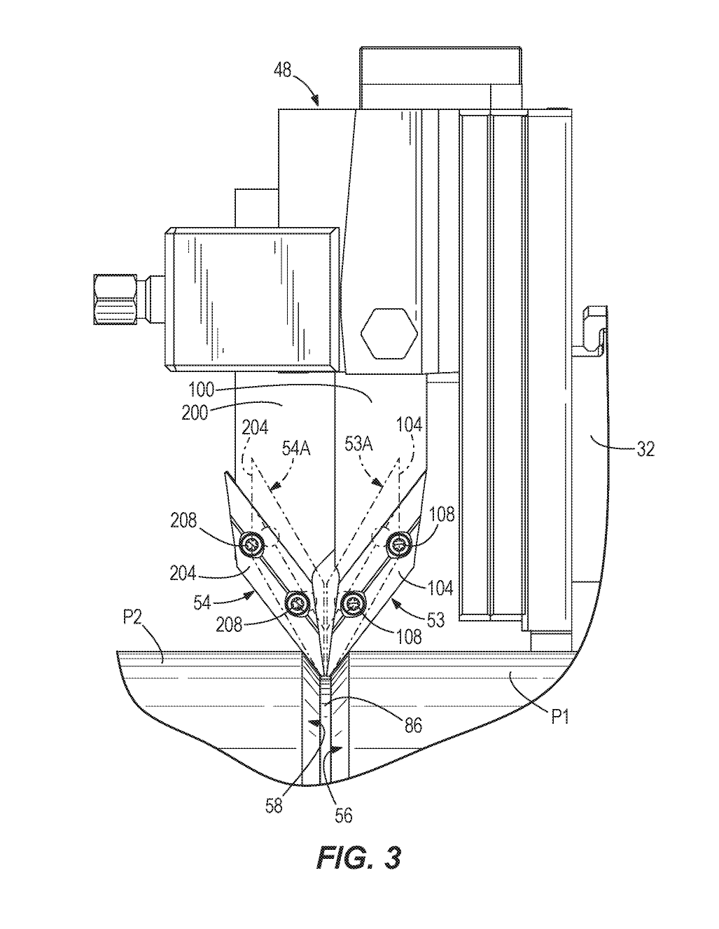

With continued reference to FIG. 1 and further reference to FIGS. 2 and 3, tools 53 and 54 will be described in further detail. Tool 52 cuts a groove 86 into the pipe P and tools 53, 54 are configured to bevel ends 56, 58 of cut pieces P1, P2 of a pipe P at desired angles. The tool 53 bevels an end 56 of a first cut piece P1 of pipe and tool 54 bevels an end 58 of a second cut piece P2 of pipe. In the illustrated example, the tool support 48 supports both tools 53, 54 for beveling ends 56, 58 of both cut pieces P1, P2 of a pipe. In other examples, the tool support 48 may only support tool 53 for beveling an end 56 of the first cut piece P1 of pipe and the end 58 of the second cut piece P2 of pipe will not be beveled. In further examples, the tool support 48 may only support tool 54 for beveling an end 58 of the second cut piece P2 of pipe and the end 56 of the first cut piece P1 of pipe will not be beveled.

In the illustrated example, tools 53, 54 cut bevels along planes 60, 62 that are transverse to the longitudinal axis A of the pipe and at about 37.5 degrees from perpendicularity to the longitudinal axis A. Tools 53, 54 may be interchangeable with other tools that cut bevels along planes that are transverse to the longitudinal axis A of the pipe and at different angles from perpendicularity to the longitudinal axis A. For example, as illustrated in dashed lines, tools 53A, 54A may be interchanged with tools 53, 54 and may bevel ends 56, 58 of the two cut pieces P1, P2 of pipe at about 30 degrees from perpendicularity to the longitudinal axis A of the pipe.

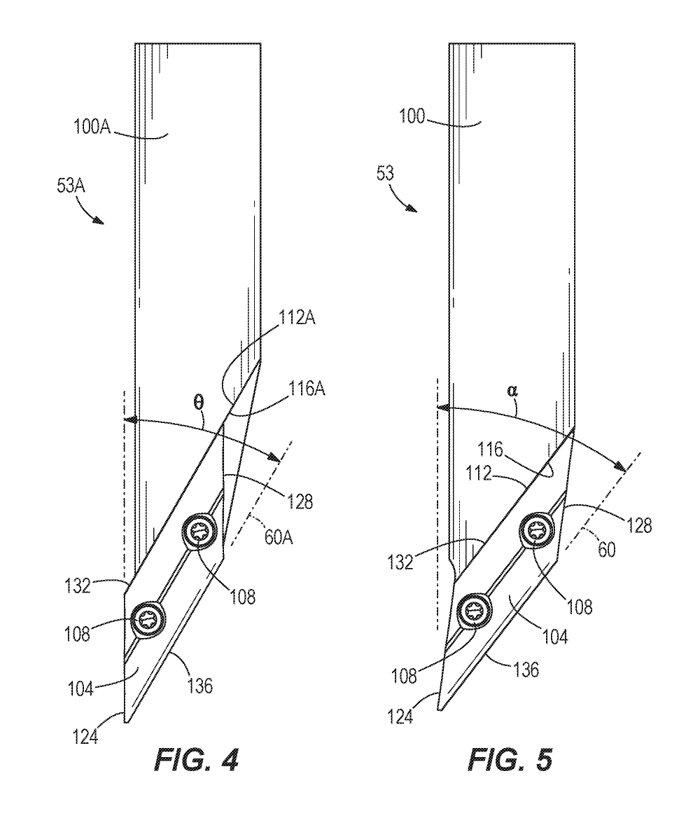

Referring now to FIG. 4, the tool 53A is illustrated and is configured to bevel an end 56 of a first cut piece P1 of the pipe. In some examples, the bevel cut into the end 56 of the first cut piece P1 of pipe may be referred to as an inside bevel and tool 53A may be referred to as an inside bevel tool. In the illustrated example, the tool 53A includes a base 100A and a cutting insert 104 coupled to the base 100A. The cutting insert 104 may be coupled to the base 100A in a variety of manners and all of such manners are intended to be within the spirit and scope of the present disclosure. In the illustrated example, the cutting insert 104 is coupled to the base 100A with two coupling members or fasteners 108. In other examples, the cutting insert 104 may be coupled to the base 100A using any number of fasteners and all of such possibilities are intended to be included in the spirit and scope of the present disclosure. The base 100A defines a projection or lip 112A having an engagement surface 116A that is configured to be engaged by the cutting insert 104. The base 100A also defines coupling apertures 120A therein configured to receive the coupling members 108 therein. Similarly to the alternative examples associated with the coupling members 108, the base 100A may include any number of coupling apertures 120A to correspond to the number of coupling members 108.

With continued reference to FIG. 4, the cutting insert 104 includes a first cutting edge 124, a second cutting edge 128 positioned opposite the first cutting edge 124, and third and fourth edges 132, 136 opposite each other and between the first and second cutting edges 124, 128. In the illustrated example, the first and second cutting edges 124, 128 are generally parallel to each other and the third and fourth edges 132, 136 are generally parallel to each other. In other examples, the edges of the cutting insert 104 may be oriented differently relative to each other and all of such possibilities are intended to within the spirit and scope of the present disclosure. The cutting insert 104 also defines apertures 140 there through that are alignable with coupling apertures 120A defined in the base 100A. The coupling members 108 are positioned in the aligned apertures 120A, 140 therein to couple the insert 104 to the base 100A. Similarly to the alternative examples associated with the coupling members 108 and coupling apertures 120A of the base 100A, the cutting insert 104 may include any number of apertures 140 to correspond to the number of coupling members 108 and coupling apertures 120A in the base 100A.

In the illustrated example, the third edge 132 of the cutting insert 104 engages the engagement surface 116A of the base 100A. The lip 112A, the engagement surface 116A, the location of the coupling apertures 120A and the shape of the cutting insert 104 cooperate to ensure the cutting insert 104 is at an appropriate orientation to bevel the end 56 of the first cut piece P1 of the pipe at an appropriate angle α. In the illustrated example, these elements cooperate to ensure the cutting insert 104 bevels the end 56 of the first cut piece P1 of the pipe at about a 30-degree angle (i.e., α=about 30 degrees). The cutting insert 104 may also be rotated 180 degrees to bring the fourth edge 136 of the cutting insert 104 into engagement with the engagement surface 116A of the lip 112A. Again, the lip 112A, the engagement surface 116A, the location of the coupling apertures 120A and the shape of the cutting insert 104 cooperate to ensure the cutting insert 104 is at an appropriate orientation to bevel the end 56 of the first cut piece P1 of the pipe at an appropriate angle α (e.g., α=about 30 degrees). The two cutting edges 124, 128 may provide the cutting insert 104 with additional life compared to a cutting insert that only includes one cutting edge.

The cutting insert 104 is the portion of the cutting tool 53A that engages, cuts and bevels the pipe P. Thus, the cutting insert 104 may be made of a material appropriate for cutting a pipe P while the base 100A of the cutting tool 53A may be made of a different material. The material from which the cutting insert 104 is made may be more expensive of a material than the material from which the base 100A is made. Typical cutting tools may be made completely of the material required to cut a pipe. Thus, the total cost of the cutting tool 53A may be reduced from past cutting tools made completely of a material required to cut a pipe.

Referring now to FIG. 5, the tool 53 is illustrated and is configured to bevel an end 56 of a first cut piece P1 of the pipe. Tools 53 and 53A may be interchangeably coupled to the tool support 48 to bevel an end 56 of the first cut piece P1 of the pipe at various angles α or θ. In some examples, the bevel cut into the end 56 of the first cut piece P1 of pipe by the tool 53 may be referred to as an inside bevel and tool 53 may be referred to as an inside bevel tool. In the illustrated example, the tool 53 includes a base 100 and the cutting insert 104 coupled to the base 100. The cutting insert 104 is the same cutting insert 104 that is coupled to the base 100A of the tool 53A. Thus, the cutting insert 104 is configured to be interchangeably coupled to either the base 100A of tool 53A or the base 100 of tool 53. In this manner, only one cutting insert 104 is required to bevel the end 56 of the first cut piece P1 of the pipe at varying angles α, θ and along various transverse planes 60, 60A.

While the drawings illustrate the cutting insert 104 being configured to couple to two bases 100, 100A, it should be understood that the cutting insert 104 may be coupled to any number of bases in order to bevel an end of a pipe at any number of different angles. In this manner, the present disclosure provides any number of cutting tools to bevel an end of a pipe at any number of angles.

The cutting insert 104 is coupled to the base 100 of tool 53 in a similar manner to the base 100A of tool 53A since the cutting insert 104 is the same. That is, in the illustrated example, the cutting insert 104 is coupled to the base 100 with the two coupling members or fasteners 108. The same alternative examples described above in connection with coupling the cutting insert 104 to the base 100A of tool 53A also apply to coupling the cutting insert 104 to the base 100 of tool 53 since the cutting insert 104 is coupled similarly to both the base 100A of tool 53A and the base 100 of tool 53. The base 100 of tool 53 also defines a projection or lip 112 having an engagement surface 116 that is configured to be engaged by the cutting insert 104. The base 100 also defines coupling apertures 120 therein configured to receive the coupling members 108 therein.

With continued reference to FIG. 5, the lip 112, the engagement surface 116, the location of the coupling apertures 120 and the shape of the cutting insert 104 cooperate to ensure the cutting insert 104 is at an appropriate orientation to bevel the end 56 of the first cut piece P1 of the pipe at an appropriate angle θ. In the illustrated example, these elements cooperate to ensure the cutting insert 104 bevels the end 56 of the first cut piece P1 of the pipe at about a 37.5-degree angle (i.e., 0=about 37.5 degrees). The cutting insert 104 may also be rotated 180 degrees to bring the fourth edge 136 of the cutting insert 104 into engagement with the engagement surface 116 of the lip 112. Again, the lip 112, the engagement surface 116, the location of the coupling apertures 120 and the shape of the cutting insert 104 cooperate to ensure the cutting insert 104 is at an appropriate orientation to bevel the end 56 of the first cut piece P1 of the pipe at an appropriate angle θ (e.g., θ=about 37.5 degrees).

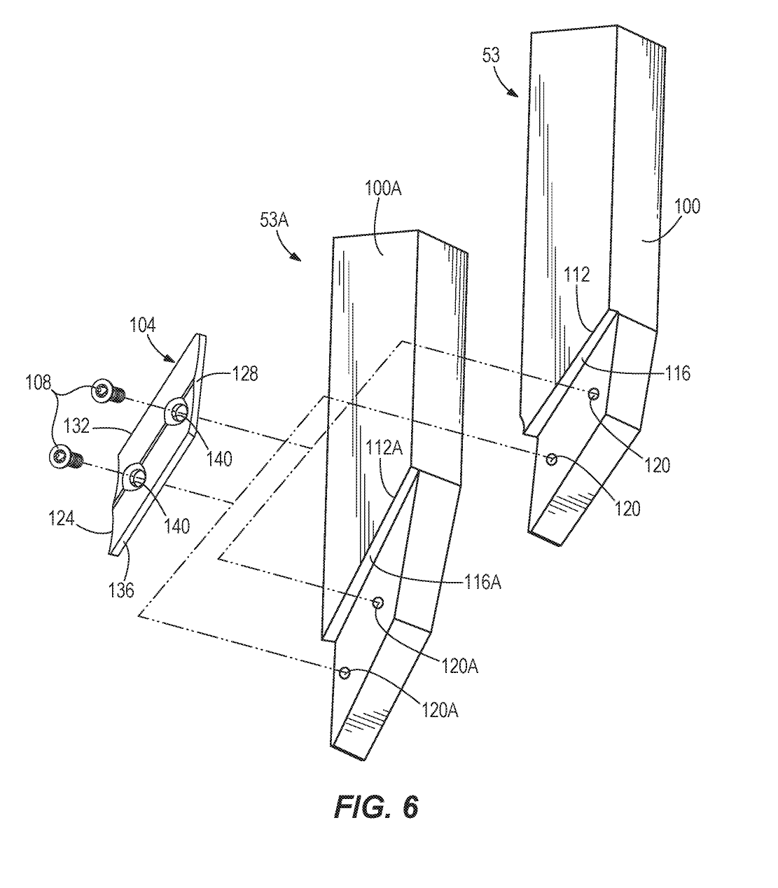

Referring now to FIG. 6, the cutting insert 104 is illustrated in a manner that demonstrates interchangeable coupling of the cutting insert 104 with either the base 100A of tool 53A or the base 100 of cutting tool 53. The elements of the bases 100, 100A and the cutting insert 104 position the cutting insert 104 in the appropriate orientation to bevel the end 56 of the first cut piece P1 of pipe at multiple angles α, θ and along multiple planes 60, 60A transverse to the longitudinal axis A of the pipe P.

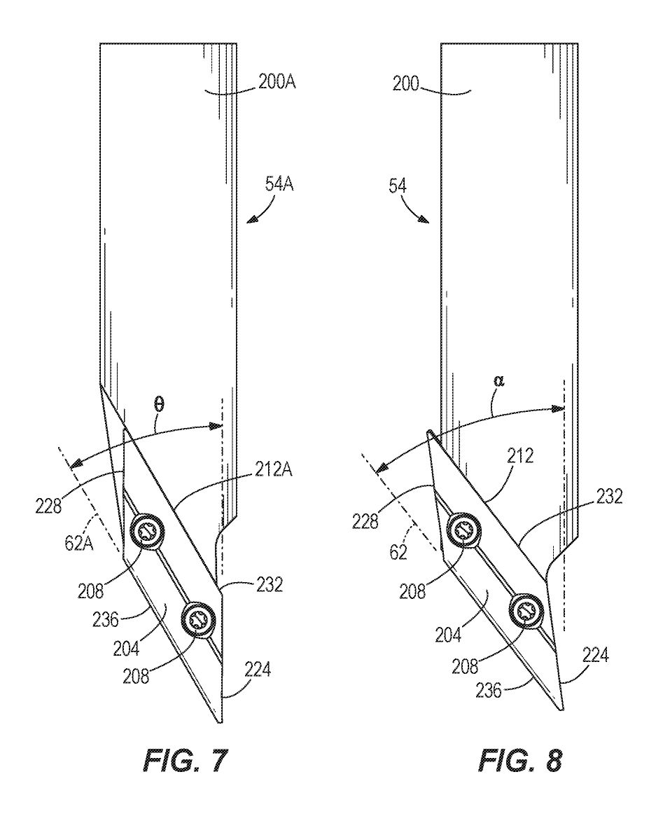

Referring now to FIG. 7, the tool 54A is illustrated and is configured to bevel an end 58 of a second cut piece P2 of the pipe. In some examples, the bevel cut into the end 58 of the second cut piece P2 of pipe may be referred to as an outside bevel and tool 54A may be referred to as an outside bevel tool. In the illustrated example, the tool 54A includes a base 200A and a cutting insert 204 coupled to the base 200A. The cutting insert 204 may be coupled to the base 200A in a variety of manners and all of such manners are intended to be within the spirit and scope of the present disclosure. In the illustrated example, the cutting insert 204 is coupled to the base 200A with two coupling members or fasteners 208. In other examples, the cutting insert 204 may be coupled to the base 200A using any number of fasteners 208 and all of such possibilities are intended to be included in the spirit and scope of the present disclosure. The base 200A defines a projection or lip 212A having an engagement surface 216A that is configured to be engaged by the cutting insert 204. The base 200A also defines coupling apertures 220A therein configured to receive the coupling members 208 therein. Similarly to the alternative examples associated with the coupling members 208, the base 200A may include any number of coupling apertures 220A to correspond to the number of coupling members 208.

With continued reference to FIG. 7, the cutting insert 204 includes a first cutting edge 224, a second cutting edge 228 positioned opposite the first cutting edge 224, and third and fourth edges 232, 236 opposite each other and between the first and second cutting edges 224, 228. In the illustrated example, the first and second cutting edges 224, 228 are generally parallel to each other and the third and fourth edges 232, 236 are generally parallel to each other. In other examples, the edges of the cutting insert 204 may be oriented differently relative to each other and all of such possibilities are intended to within the spirit and scope of the present disclosure. The cutting insert 204 also defines apertures 240 there through that are alignable with coupling apertures 220A defined in the base 200A. The coupling members 208 are positionable in the aligned apertures 220A, 240 to couple the insert 204 to the base 200A. Similarly to the alternative examples associated with the coupling members 208 and coupling apertures 220A of the base 200A, the cutting insert 204 may include any number of apertures 240 to correspond to the number of coupling members 208 and coupling apertures 220A in the base 200A.

In the illustrated example, the third edge 232 of the cutting insert 204 engages the engagement surface 216A of the base 200A. The lip 212A, the engagement surface 216A, the location of the coupling apertures 220A and the shape of the cutting insert 204 cooperate to ensure the cutting insert 204 is at an appropriate orientation to bevel the end 58 of the second cut piece P2 of the pipe at an appropriate angle α. In the illustrated example, these elements cooperate to ensure the cutting insert 204 bevels the end 58 of the second cut piece P2 of the pipe at about a 30-degree angle (i.e., α=about 30 degrees). The cutting insert 204 may also be rotated 180 degrees to bring the fourth edge 236 of the cutting insert 204 into engagement with the engagement surface 216A of the lip 212A. Again, the lip 212A, the engagement surface 216A, the location of the coupling apertures 220A and the shape of the cutting insert 204 cooperate to ensure the cutting insert 204 is at an appropriate orientation to bevel the end 58 of the second cut piece P2 of the pipe at an appropriate angle α (e.g., α=about 30 degrees). The two cutting edges 224, 228 may provide the cutting insert with additional life compared to a cutting insert that only includes one cutting edge.

The cutting insert 204 is the portion of the cutting tool 54A that engages, cuts and bevels the pipe P. Thus, the cutting insert 204 may be made of a material appropriate for cutting a pipe P while the base 200A of the cutting tool 54A may be made of a different material. The material from which the cutting insert 204 is made may be more expensive of a material than the material from which the base 200A is made. Typical cutting tools may be made completely of the material required to cut a pipe. Thus, the total cost of the cutting tool 54A may be reduced from past cutting tools made completely of a material required to cut a pipe P.

Referring now to FIG. 8, the tool 54 is illustrated and is configured to bevel an end 58 of a second cut piece P2 of the pipe. Tools 54 and 54A may be interchangeably coupled to the tool support 48 to bevel an end 58 of the second cut piece P2 of the pipe at various angles α or θ. In some examples, the bevel cut into the end 58 of the second cut piece P2 of pipe by the tool 54 may be referred to as an outside bevel and tool 54 may be referred to as an outside bevel tool. In the illustrated example, the tool 54 includes a base 200 and the cutting insert 204 coupled to the base 200. The cutting insert 204 is the same cutting insert 204 that is coupled to the base 200A of the tool 54A. Thus, the cutting insert 204 is configured to be interchangeably coupled to either the base 200A of tool 54A or the base 200 of tool 54. In this manner, only one cutting insert 204 is required to bevel the end 58 of the second cut piece P2 of the pipe at varying angles α, θ and along various transverse planes 62, 62A.

The cutting insert 204 is coupled to the base 200 of tool 54 in a similar manner to the base 200A of tool 54A since the cutting insert 204 is the same. That is, in the illustrated example, the cutting insert 204 is coupled to the base 200 with two coupling members or fasteners 208. The same alternative examples described above in connection with coupling the cutting insert 204 o the base 200A of tool 54A also apply to coupling the cutting insert 204 to the base 200 of tool 54 since the cutting insert 204 is coupled similarly to both the base 200A of tool 54A and the base 200 of tool 54. The base 200 of tool 54 also defines a projection or lip 212 having an engagement surface 216 that is configured to be engaged by the cutting insert 204. The base 200 also defines coupling apertures 220 therein configured to receive the coupling members 208 therein.

With continued reference to FIG. 8, the lip 212, the engagement surface 216, the location of the coupling apertures 220 and the shape of the cutting insert 204 cooperate to ensure the cutting insert 204 is at an appropriate orientation to bevel the end 58 of the second cut piece P2 of the pipe at an appropriate angle θ. In the illustrated example, these elements cooperate to ensure the cutting insert 204 bevels the end 58 of the second cut piece P2 of the pipe at about a 37.5-degree angle (i.e., θ=about 37.5 degrees). The cutting insert 204 may also be rotated 180 degrees to bring the fourth edge 236 of the cutting insert 204 into engagement with the engagement surface 216 of the lip 212. Again, the lip 212, the engagement surface 216, the location of the coupling apertures 220 and the shape of the cutting insert 204 cooperate to ensure the cutting insert 204 is at an appropriate orientation to bevel the end 58 of the second cut piece P2 of the pipe at an appropriate angle θ (e.g., θ=about 37.5 degrees).

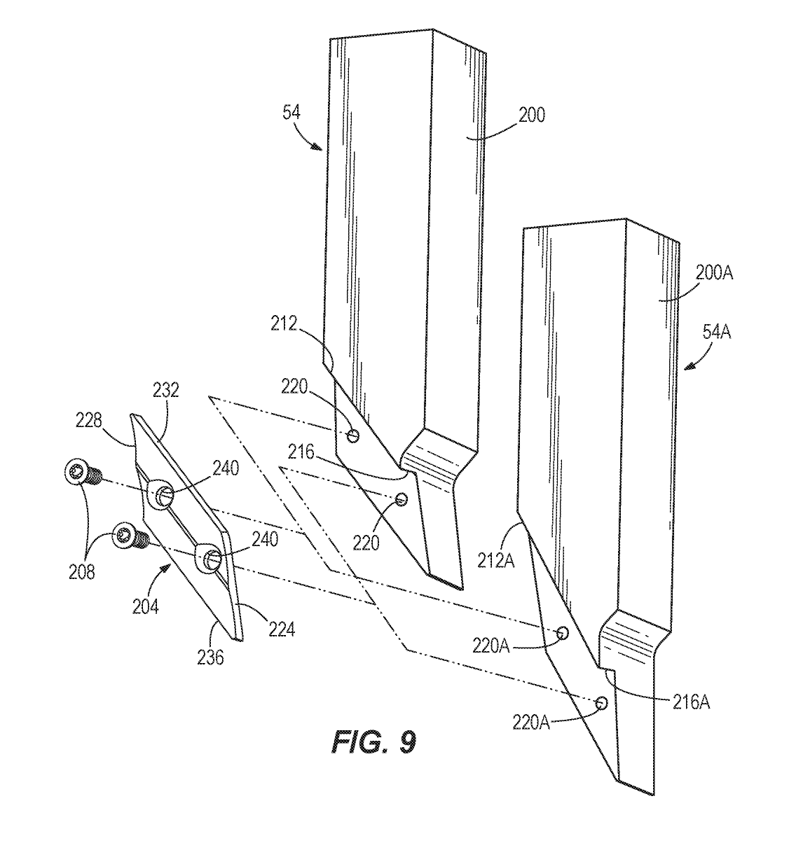

Referring now to FIG. 9, the cutting insert 204 is illustrated in a manner that demonstrates interchangeable coupling of the cutting insert 204 with either the base 200A of tool 54A or the base 200 of cutting tool 54. The elements of the bases 200, 200A and the cutting insert 204 position the cutting insert 204 in the appropriate orientation to bevel the end 58 of the second cut piece P2 of pipe at multiple angles α, θ and along multiple planes 62, 62A transverse to the longitudinal axis A of the pipe P.

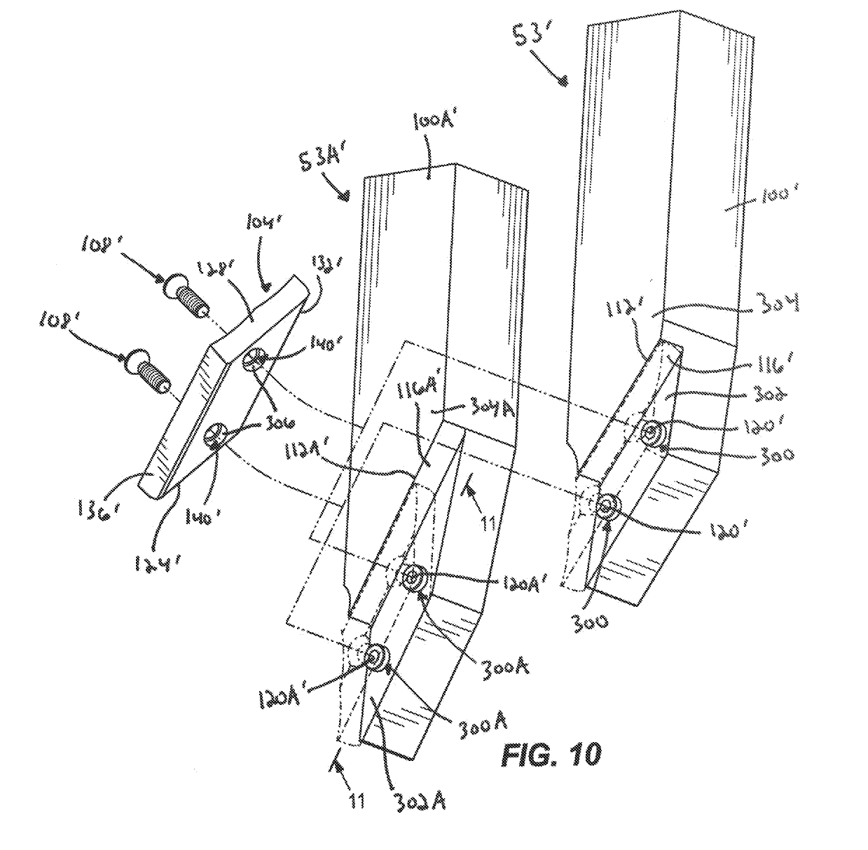

Referring now to FIGS. 10-13, other examples of tools 53′, 53A′, 54′, 54A′ are illustrated and are identified with reference numbers and an “′”. Tools 53′, 53A′, 54′, 54A′ are capable of having at least some of the same structure, function and alternatives as the tools 53, 53A, 54, 54A illustrated in FIGS. 1-9 and the pertinent description above with respect to tools 53, 53A, 54, 54A applies to tools 53′, 53A′, 54′, 54A′. At least some of the differences between tools 53′, 53A′, 54′, 54A′ and tools 53, 53A, 54, 54A will be described herein.

With reference to FIGS. 10-13, tools 53′ and 54′ will be described in further detail. Tools 53′, 54′ are configured to bevel ends 56, 58 of cut pieces P1, P2 of a pipe P at desired angles. The tool 53′ bevels an end 56 of a first cut piece P1 of pipe and tool 54′ bevels an end 58 of a second cut piece P2 of pipe. In the illustrated example, the tool support 48 supports both tools 53′, 54′ for beveling ends 56, 58 of both cut pieces P1, P2 of a pipe. In other examples, the tool support 48 may only support tool 53′ for beveling an end 56 of the first cut piece P1 of pipe and the end 58 of the second cut piece P2 of pipe will not be beveled. In further examples, the tool support 48 may only support tool 54′ for beveling an end 58 of the second cut piece P2 of pipe and the end 56 of the first cut piece P1 of pipe will not be beveled.

In the illustrated example, tools 53′, 54′ cut bevels along planes 60, 62 that are transverse to the longitudinal axis A of the pipe and at about 37.5 degrees from perpendicularity to the longitudinal axis A. Tools 53′, 54′ may be interchangeable with other tools that cut bevels along planes that are transverse to the longitudinal axis A of the pipe and at different angles from perpendicularity to the longitudinal axis A. For example, tools 53A′, 54A′ may be interchanged with tools 53′, 54′ and may bevel ends 56, 58 of the two cut pieces P1, P2 of pipe at about 30 degrees from perpendicularity to the longitudinal axis A of the pipe (tools 53A′, 54A′ described in more detail below).

With particular reference to FIG. 10, the tool 53′ is illustrated and is configured to bevel an end 56 of a first cut piece P1 of the pipe. In some examples, the bevel cut into the end 56 of the first cut piece P1 of pipe may be referred to as an inside bevel and tool 53′ may be referred to as an inside bevel tool. In the illustrated example, the tool 53′ includes a base 100′ and a cutting insert 104′ coupled to the base 100′. The cutting insert 104′ may be coupled to the base 100′ in a variety of manners and all of such manners are intended to be within the spirit and scope of the present disclosure. In the illustrated example, the cutting insert 104′ is coupled to the base 100′ with two coupling members or fasteners 108′. In other examples, the cutting insert 104′ may be coupled to the base 100′ using any number of fasteners and all of such possibilities are intended to be included in the spirit and scope of the present disclosure. The base 100′ defines a projection or lip 112′ having an engagement surface 116′ that is configured to be engaged by the cutting insert 104′.

In the illustrated example, the base 100′ also includes a pair of projections, hubs or raised surfaces 300 extending or protruding from a surface 302 of the base 100′. The base 100′ also includes a second surface 304 that is non-planar with the surface 302. The lip 112 extends between the two surfaces 302, 304. In one example, the surface 302 is recessed relative to the second surface 304. The projections 300 may extend from the surface 302 any extent and all of such possibilities are intended to be within the spirit and scope of the present disclosure. In one example, the projections 300 extend from the surface 302 a first distance such that the projections 300 do not extend beyond the second surface 304 of the base 100′. In another example, the projections 300 may extend from the surface 302 such that ends of the projections 300 are flush or co-planar with the second surface 304. In a further example, the projections 300 may extend a third distance such that the ends of the projections 300 are beyond the second surface 304. In the illustrated example, the projections 300 are round in shape. In other examples, the projections 300 may have any shape such as, for example, any shape having a polygonal perimeter, arcuate perimeter or a combination of polygonal and arcuate perimetered shape. It should be understood that the base 100′ is capable of having any number of projections 300 (including zero, one or more than two) and all of such possibilities are intended to be within the spirit and scope of the present disclosure.

In the illustrated example, the base 100′ defines coupling apertures 120′ in the projections 300 configured to receive the coupling members 108′ therein. The base 100′ may include any number of projections 300 and corresponding coupling apertures 120′ to correspond to the number of coupling members 108′.

With particular reference to FIG. 10, the tool 53A′ is illustrated and is configured to bevel an end 56 of a first cut piece P1 of the pipe. In some examples, the bevel cut into the end 56 of the first cut piece P1 of pipe may be referred to as an inside bevel and tool 53A′ may be referred to as an inside bevel tool. In the illustrated example, the tool 53A′ includes a base 100A′ and a cutting insert 104′ coupled to the base 100A′. The cutting insert 104′ may be coupled to the base 100A′ in a variety of manners and all of such manners are intended to be within the spirit and scope of the present disclosure. In the illustrated example, the cutting insert 104′ is coupled to the base 100A′ with two coupling members or fasteners 108′. In other examples, the cutting insert 104′ may be coupled to the base 100A′ using any number of fasteners and all of such possibilities are intended to be included in the spirit and scope of the present disclosure. The base 100A′ defines a projection or lip 112A′ having an engagement surface 116A′ that is configured to be engaged by the cutting insert 104′.

In the illustrated example, the base 100A′ also includes a pair of projections, hubs or raised surfaces 300A extending or protruding from a surface 302A of the base 100A′. The base 100A′ also includes a second surface 304A that is non-planar with the surface 302A. The lip 112A′ extends between the two surfaces 302A, 304A. In one example, the surface 302A is recessed relative to the second surface 304A. The projections 300A may extend from the surface 302A any extent and all of such possibilities are intended to be within the spirit and scope of the present disclosure. In one example, the projections 300A extend from the surface 302A a first distance such that the projections 300A do not extend beyond the second surface 304A of the base 100A′. In another example, the projections 300A may extend from the surface 302A such that ends of the projections 300A are flush or co-planar with the second surface 304A. In a further example, the projections 300A may extend a third distance such that the ends of the projections 300A are beyond the second surface 304A. In the illustrated example, the projections 300A are round in shape. In other examples, the projections 300A may have any shape such as, for example, any shape having a polygonal perimeter, arcuate perimeter or a combination of polygonal and arcuate perimetered shape. It should be understood that the base 100A′ is capable of having any number of projections 300A (including zero, one or more than two) and all of such possibilities are intended to be within the spirit and scope of the present disclosure.

In the illustrated example, the base 100A′ defines coupling apertures 120A′ in the projections 300A configured to receive the coupling members 108′ therein. The base 100A′ may include any number of projections 300A and corresponding coupling apertures 120A′ to correspond to the number of coupling members 108′.

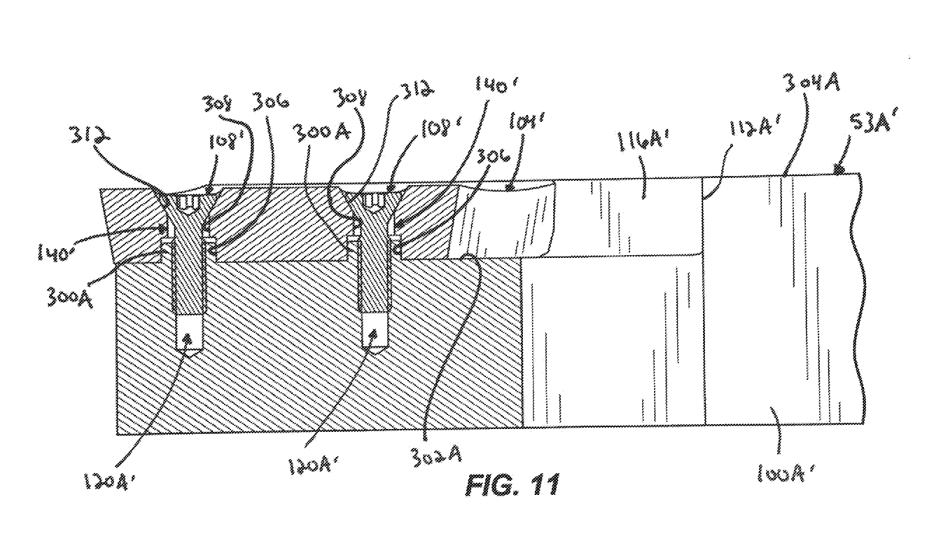

With continued reference to FIG. 10 and additional reference to FIG. 11, the cutting insert 104′ includes a first cutting edge 124′, a second cutting edge 128′ positioned opposite the first cutting edge 124′, and third and fourth edges 132′, 136′ opposite each other and between the first and second cutting edges 124′, 128′. In the illustrated example, the first and second cutting edges 124′, 128′ are generally parallel to each other and the third and fourth edges 132′, 136′ are generally parallel to each other. In other examples, the edges of the cutting insert 104′ may be oriented differently relative to each other and all of such possibilities are intended to within the spirit and scope of the present disclosure.

In the illustrated example, the cutting insert 104′ also defines apertures 140′ there through that cooperate with the projections 300, 300A and the coupling apertures 120′, 120A′ on the bases 100′, 100A′. The cutting insert 104′ is configured to interchangeably couple to both tools 53′, 53A′; however, for the sake of brevity, the following description of the cutting insert 104′ will be described with respect to tool 53A′. It should be understood that the following description of the cutting insert 104′ and the tool 53A′ also applies to the tool 53′.

In the illustrated example, the apertures 140′ are identical in shape and configuration. Accordingly, only one of the apertures 140′ will be described herein in detail with it being understood that the following description pertains to all possible apertures 140′. In the illustrated example, each aperture 140′ includes a plurality of portions or sections. In one example, the aperture 140′ includes a first portion 306, a second portion 308 and a third portion 312. The first portion 306 extends in from a first side of the cutting insert 104′ and has a first configuration for receiving one of the projections 300A of the base 100A′. The second portion 308 is disposed between and is in fluid (air) communication with the first and third portions 306, 312. The second portion 308 has a second configuration. The third portion 312 extends in from a second side of the cutting insert 104′ opposite from the first portion 306 and has a third configuration. In the illustrated example, the first configuration is substantially round in cross-section and is complementarily sized and shaped to receive one of the projections 300A, the second configuration is substantially round in cross-section and is smaller in diameter than the first configuration and is sized and shaped to tightly tolerance a shaft of the coupling member 108′, and the third configuration is frusto-conical or counter-sunk in shape and is complementary to the size of a head of the coupling member 108′.

The apertures 140′ are alignable with coupling apertures 120A′ defined in the base 100A′. The projections 300A are positioned in the first portion 306 of the cutting insert 104′ and the coupling members 108′ are positioned in the aligned apertures 120A′, 140′ to couple the insert 104′ to the base 100A′.

The engagement and cooperation of the projections 300, 300A and the first portions 306 of the apertures 140′ provide a stronger and more rigid coupling between the cutting insert 104′ and the bases 100′, 100A′. During operation of the tools, the fasteners 108′ are less likely to be sheared-off by the forces applied thereto due to the additional engagement between the projections 300, 300A and the apertures 140′. The cutting insert 104′ may include any number of apertures 140′ to correspond to the number of coupling members 108′ and coupling apertures 120′, 120A′ in the bases 100′, 100A′.

In the illustrated example, the third edge 132′ of the cutting insert 104′ engages the engagement surface 116A′ of the base 100A′. The lip 112A′, the engagement surface 116A′, the location of the coupling apertures 120A′ and the shape of the cutting insert 104′ cooperate to ensure the cutting insert 104′ is at an appropriate orientation to bevel the end 56 of the first cut piece P1 of the pipe at an appropriate angle α. In the illustrated example, these elements cooperate to ensure the cutting insert 104′ bevels the end 56 of the first cut piece P1 of the pipe at about a 30-degree angle (i.e., α=about 30 degrees). The cutting insert 104′ may also be rotated 180 degrees to bring the fourth edge 136′ of the cutting insert 104′ into engagement with the engagement surface 116A′ of the lip 112A′. Again, the lip 112A′, the engagement surface 116A′, the location of the coupling apertures 120A′ and the shape of the cutting insert 104′ cooperate to ensure the cutting insert 104′ is at an appropriate orientation to bevel the end 56 of the first cut piece P1 of the pipe at an appropriate angle α (e.g., α=about 30 degrees). The two cutting edges 124′, 128′ may provide the cutting insert 104′ with additional life compared to a cutting insert that only includes one cutting edge.

The cutting insert 104′ is the portion of the cutting tool 53A′ that engages, cuts and bevels the pipe P. Thus, the cutting insert 104′ may be made of a material appropriate for cutting a pipe P while the base 100A′ of the cutting tool 53A′ may be made of a different material. The material from which the cutting insert 104′ is made may be more expensive of a material than the material from which the base 100A′ is made. Typical cutting tools may be made completely of the material required to cut a pipe. Thus, the total cost of the cutting tool 53A′ may be reduced from past cutting tools made completely of a material required to cut a pipe.

With continued reference to FIG. 10, the tool 53′ is illustrated and is configured to bevel an end 56 of a first cut piece P1 of the pipe. Tools 53′ and 53A′ may be interchangeably coupled to the tool support 48 to bevel an end 56 of the first cut piece P1 of the pipe at various angles α or β. In some examples, the bevel cut into the end 56 of the first cut piece P1 of pipe by the tool 53′ may be referred to as an inside bevel and tool 53′ may be referred to as an inside bevel tool. In the illustrated example, the tool 53′ includes a base 100′ and the cutting insert 104′ coupled to the base 100′. The cutting insert 104′ is the same cutting insert 104′ that is coupled to the base 100A′ of the tool 53A′. Thus, the cutting insert 104′ is configured to be interchangeably coupled to either the base 100A′ of tool 53A′ or the base 100′ of tool 53′. In this manner, only one cutting insert 104′ is required to bevel the end 56 of the first cut piece P1 of the pipe at varying angles α, θ and along various transverse planes 60, 60A.

While the drawings illustrate the cutting insert 104′ being configured to couple to two bases 100′, 100A′, it should be understood that the cutting insert 104′ may be coupled to any number of bases in order to bevel an end of a pipe at any number of different angles. In this manner, the present disclosure provides any number of cutting tools to bevel an end of a pipe at any number of angles.

The cutting insert 104′ is coupled to the base 100′ of tool 53′ in a similar manner to the base 100A′ of tool 53A′ since the cutting insert 104′ is the same. That is, in the illustrated example, the cutting insert 104′ is coupled to the base 100′ with the two coupling members or fasteners 108′. The same alternative examples described above in connection with coupling the cutting insert 104′ to the base 100A′ of tool 53A′ also apply to coupling the cutting insert 104′ to the base 100′ of tool 53′ since the cutting insert 104′ is coupled similarly to both the base 100A′ of tool 53A′ and the base 100′ of tool 53′. The base 100′ of tool 53′ also defines a projection or lip 112′ having an engagement surface 116′ that is configured to be engaged by the cutting insert 104′. The base 100′ also includes projections 300 and coupling apertures 120′ defined in the projections 300 configured to receive the coupling members 108′ therein.

With further reference to FIG. 10 and tool 53′, the lip 112′, the engagement surface 116′, the location of the coupling apertures 120′ and the shape of the cutting insert 104′ cooperate to ensure the cutting insert 104′ is at an appropriate orientation to bevel the end 56 of the first cut piece P1 of the pipe at an appropriate angle θ. In the illustrated example, these elements cooperate to ensure the cutting insert 104′ bevels the end 56 of the first cut piece P1 of the pipe at about a 37.5-degree angle (i.e., θ=about 37.5 degrees). The cutting insert 104′ may also be rotated 180 degrees to bring the fourth edge 136′ of the cutting insert 104′ into engagement with the engagement surface 116′ of the lip 112′. Again, the lip 112′, the engagement surface 116′, the location of the coupling apertures 120′ and the shape of the cutting insert 104′ cooperate to ensure the cutting insert 104′ is at an appropriate orientation to bevel the end 56 of the first cut piece P1 of the pipe at an appropriate angle θ (e.g., θ=about 37.5 degrees).

In FIG. 10, the cutting insert 104′ is illustrated in a manner that demonstrates interchangeable coupling of the cutting insert 104′ with either the base 100A′ of tool 53A′ or the base 100′ of cutting tool 53′. The elements of the bases 100′, 100A′ and the cutting insert 104′ position the cutting insert 104′ in the appropriate orientation to bevel the end 56 of the first cut piece P1 of pipe at multiple angles α, θ and along multiple planes 60, 60A transverse to the longitudinal axis A of the pipe P.

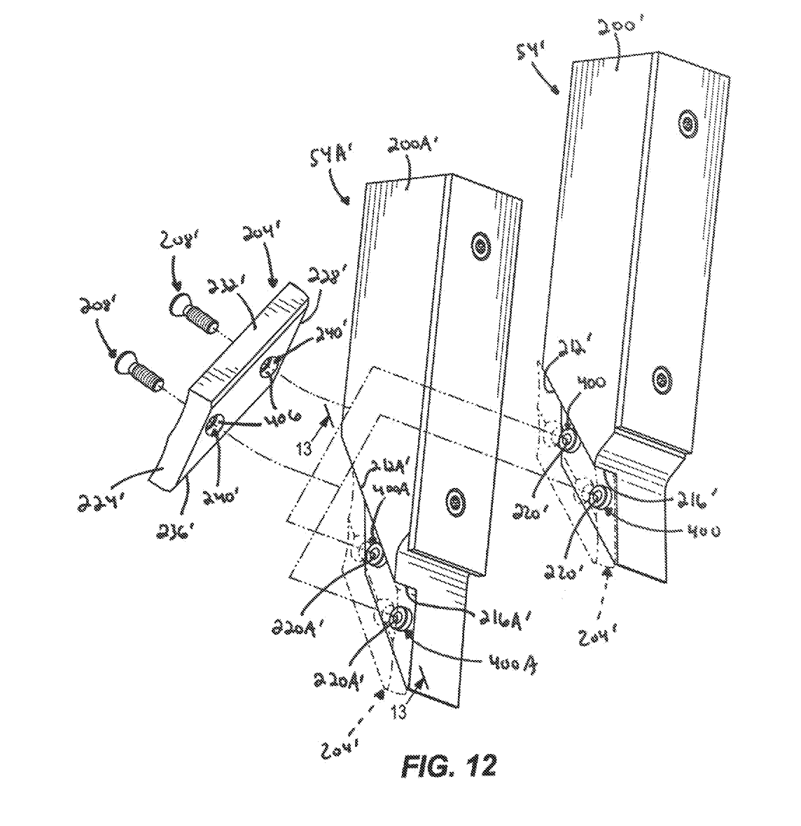

Referring now to FIG. 12, the tool 54A′ is illustrated and is configured to bevel an end 58 of a second cut piece P2 of the pipe. In some examples, the bevel cut into the end 58 of the second cut piece P2 of pipe may be referred to as an outside bevel and tool 54A′ may be referred to as an outside bevel tool. In the illustrated example, the tool 54A′ includes a base 200A′ and a cutting insert 204′ coupled to the base 200A′. The cutting insert 204′ may be coupled to the base 200A′ in a variety of manners and all of such manners are intended to be within the spirit and scope of the present disclosure. In the illustrated example, the cutting insert 204′ is coupled to the base 200A′ with two coupling members or fasteners 208′. In other examples, the cutting insert 204′ may be coupled to the base 200A′ using any number of fasteners 208′ and all of such possibilities are intended to be included in the spirit and scope of the present disclosure. The base 200A′ defines a projection or lip 212A′ having an engagement surface 216A′ that is configured to be engaged by the cutting insert 204′. The base 200A′ includes projections 400A similar to the projections 300, 300A described above with respect to tools 53′ and 53A′. The projections 400A of base 200A′ cooperate with the cutting insert 204′ in the same manner as described above. Such description above with respect to the projections 300, 300A and the cutting insert 104′ apply to the projections 400A of the base 200A′. The base 200A′ also defines coupling apertures 220A′ defined in the projections 400A configured to receive the coupling members 208′ therein. Similarly to the alternative examples associated with the coupling members 208′, the base 200A′ may include any number of projections 400A and coupling apertures 220A′ to correspond to the number of coupling members 208′.

With additional reference to FIG. 12, the tool 54′ is illustrated and is configured to bevel an end 58 of a second cut piece P2 of the pipe. In some examples, the bevel cut into the end 58 of the second cut piece P2 of pipe may be referred to as an outside bevel and tool 54′ may be referred to as an outside bevel tool. In the illustrated example, the tool 54′ includes a base 200′ and a cutting insert 204′ coupled to the base 200′. The cutting insert 204′ may be coupled to the base 200′ in a variety of manners and all of such manners are intended to be within the spirit and scope of the present disclosure. In the illustrated example, the cutting insert 204′ is coupled to the base 200′ with two coupling members or fasteners 208′. In other examples, the cutting insert 204′ may be coupled to the base 200′ using any number of fasteners 208′ and all of such possibilities are intended to be included in the spirit and scope of the present disclosure. The base 200′ defines a projection or lip 212′ having an engagement surface 216′ that is configured to be engaged by the cutting insert 204′. The base 200′ includes projections 400 similar to the projections 300, 300A described above with respect to tools 53′ and 53A′. The projections 400 of base 200′ cooperate with the cutting insert 204′ in the same manner as described above. Such description above with respect to the projections 300, 300A and the cutting insert 104′ apply to and projections 400 of the base 200′. The base 200′ also defines coupling apertures 220′ defined in the projections 400 configured to receive the coupling members 208′ therein. Similarly to the alternative examples associated with the coupling members 208′, the base 200′ may include any number of projections 400 and coupling apertures 220′ to correspond to the number of coupling members 208′.

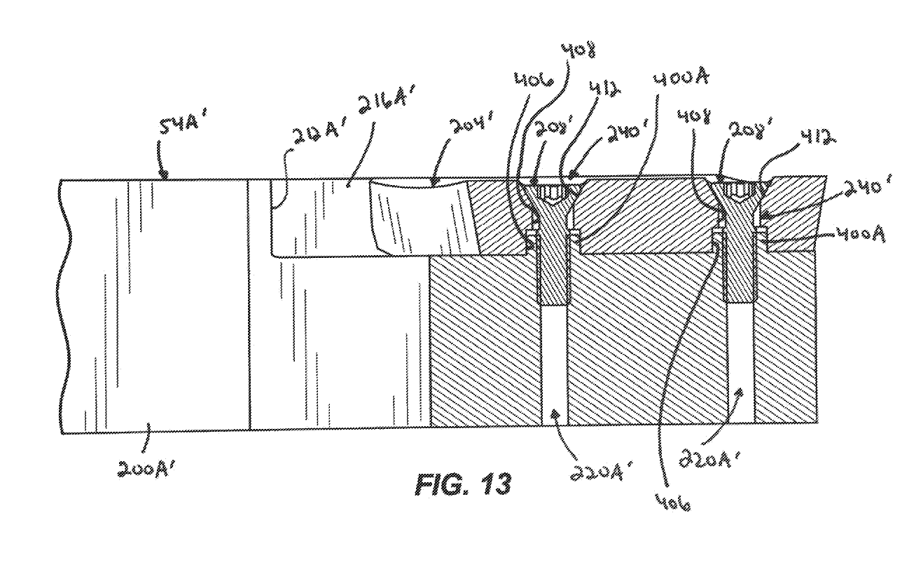

With continued reference to FIG. 12 and additional reference to FIG. 13, the cutting insert 204′ includes a first cutting edge 224′, a second cutting edge 228′ positioned opposite the first cutting edge 224′, and third and fourth edges 232′, 236′ opposite each other and between the first and second cutting edges 224′, 228′. In the illustrated example, the first and second cutting edges 224′, 228′ are generally parallel to each other and the third and fourth edges 232′, 236′ are generally parallel to each other. In other examples, the edges of the cutting insert 204′ may be oriented differently relative to each other and all of such possibilities are intended to within the spirit and scope of the present disclosure.

The cutting insert 204′ also defines apertures 240′ there through that are alignable with coupling apertures 220′, 220A′ defined in the bases 200′, 200A′. The coupling apertures 240′ are similar in configuration and function as the coupling apertures 140′ described above with respect to cutting insert 104′ and the description above with respect to coupling apertures 140′ applies to the coupling apertures 240′. The projections 400, 400A are positioned in first portions 406 of the coupling apertures 240′ and the coupling members 208′ are positionable in the aligned apertures 220A′, 240′ to couple the insert 204′ to the base 200A′. Similarly to the alternative examples associated with the coupling members 208′ and coupling apertures 220′, 220A′ of the base 200A′, the cutting insert 204′ may include any number of apertures 240′ to correspond to the number of coupling members 208′ and coupling apertures 220′, 220A′ and projections 400, 400A in the bases 200′, 200A′.

In the illustrated example, the third edge 232′ of the cutting insert 204′ engages the engagement surface 216A′ of the base 200A′. The lip 212A′, the engagement surface 216A′, the location of the coupling apertures 220A′ and the shape of the cutting insert 204′ cooperate to ensure the cutting insert 204′ is at an appropriate orientation to bevel the end 58 of the second cut piece P2 of the pipe at an appropriate angle α. In the illustrated example, these elements cooperate to ensure the cutting insert 204′ bevels the end 58 of the second cut piece P2 of the pipe at about a 30-degree angle (i.e., α=about 30 degrees). The cutting insert 204′ may also be rotated 180 degrees to bring the fourth edge 236′ of the cutting insert 204′ into engagement with the engagement surface 216A′ of the lip 212A′. Again, the lip 212A′, the engagement surface 216A′, the location of the coupling apertures 220A′ and the shape of the cutting insert 204′ cooperate to ensure the cutting insert 204′ is at an appropriate orientation to bevel the end 58 of the second cut piece P2 of the pipe at an appropriate angle α (e.g., α=about 30 degrees). The two cutting edges 224′, 228′ may provide the cutting insert with additional life compared to a cutting insert that only includes one cutting edge.

The cutting insert 204′ is the portion of the cutting tool 54A′ that engages, cuts and bevels the pipe P. Thus, the cutting insert 204′ may be made of a material appropriate for cutting a pipe P while the base 200A′ of the cutting tool 54A′ may be made of a different material. The material from which the cutting insert 204′ is made may be more expensive of a material than the material from which the base 200A′ is made. Typical cutting tools may be made completely of the material required to cut a pipe. Thus, the total cost of the cutting tool 54A′ may be reduced from past cutting tools made completely of a material required to cut a pipe P.

With further reference to FIG. 12, the tool 54′ is illustrated and is configured to bevel an end 58 of a second cut piece P2 of the pipe. Tools 54′ and 54A′ may be interchangeably coupled to the tool support 48 to bevel an end 58 of the second cut piece P2 of the pipe at various angles α or β. In some examples, the bevel cut into the end 58 of the second cut piece P2 of pipe by the tool 54′ may be referred to as an outside bevel and tool 54′ may be referred to as an outside bevel tool. In the illustrated example, the tool 54′ includes a base 200′ and the cutting insert 204′ coupled to the base 200′. The cutting insert 204′ is the same cutting insert 204′ that is coupled to the base 200A′ of the tool 54A′. Thus, the cutting insert 204′ is configured to be interchangeably coupled to either the base 200A′ of tool 54A′ or the base 200′ of tool 54′. In this manner, only one cutting insert 204′ is required to bevel the end 58 of the second cut piece P2 of the pipe at varying angles α, θ and along various transverse planes 62, 62A.

The cutting insert 204′ is coupled to the base 200′ of tool 54′ in a similar manner to the base 200A′ of tool 54A′ since the cutting insert 204′ is the same. That is, in the illustrated example, the cutting insert 204′ is coupled to the base 200′ with two coupling members or fasteners 208′. The same alternative examples described above in connection with coupling the cutting insert 204′ o the base 200A′ of tool 54A′ also apply to coupling the cutting insert 204′ to the base 200′ of tool 54′ since the cutting insert 204′ is coupled similarly to both the base 200A′ of tool 54A′ and the base 200′ of tool 54′. The base 200′ of tool 54′ also defines a projection or lip 212′ having an engagement surface 216′ that is configured to be engaged by the cutting insert 204′. The base 200′ also defines coupling apertures 220′ therein configured to receive the coupling members 208′ therein.

The lip 212′, the engagement surface 216′, the location of the coupling apertures 220′ and the shape of the cutting insert 204′ cooperate to ensure the cutting insert 204′ is at an appropriate orientation to bevel the end 58 of the second cut piece P2 of the pipe at an appropriate angle θ. In the illustrated example, these elements cooperate to ensure the cutting insert 204′ bevels the end 58 of the second cut piece P2 of the pipe at about a 37.5-degree angle (i.e., θ=about 37.5 degrees). The cutting insert 204′ may also be rotated 180 degrees to bring the fourth edge 236′ of the cutting insert 204′ into engagement with the engagement surface 216′ of the lip 212′. Again, the lip 212′, the engagement surface 216′, the location of the coupling apertures 220′ and the shape of the cutting insert 204′ cooperate to ensure the cutting insert 204′ is at an appropriate orientation to bevel the end 58 of the second cut piece P2 of the pipe at an appropriate angle θ (e.g., θ=about 37.5 degrees).

In FIG. 12, the cutting insert 204′ is illustrated in a manner that demonstrates interchangeable coupling of the cutting insert 204′ with either the base 200A′ of tool 54A′ or the base 200′ of cutting tool 54′. The elements of the bases 200′, 200A′ and the cutting insert 204′ position the cutting insert 204′ in the appropriate orientation to bevel the end 58 of the second cut piece P2 of pipe at multiple angles α, θ and along multiple planes 62, 62A transverse to the longitudinal axis A of the pipe P.

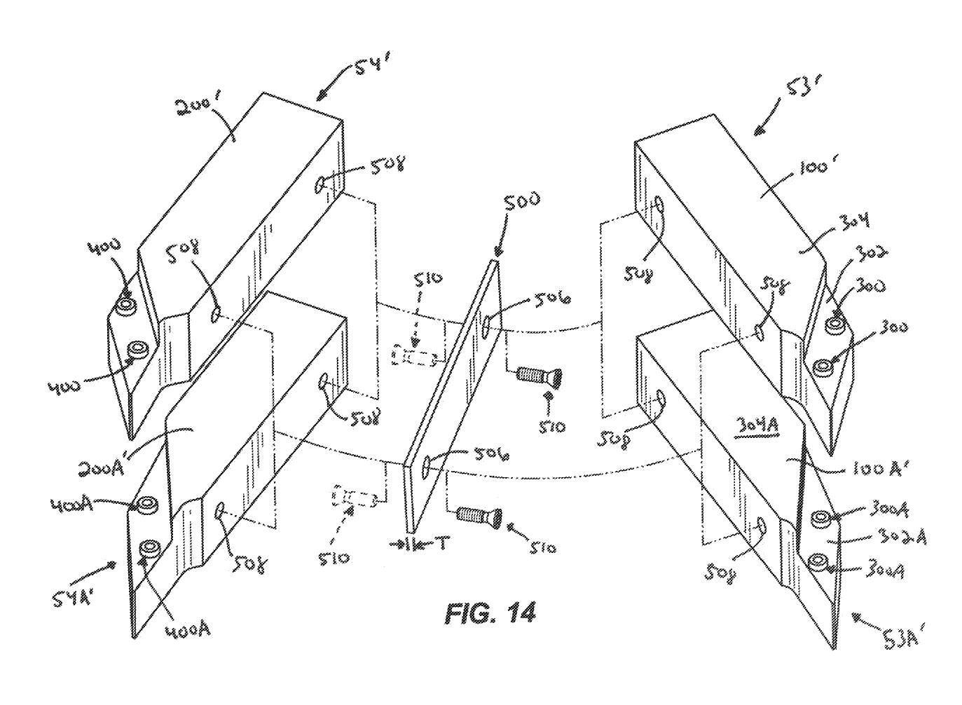

Referring now to FIGS. 14-16, one example of a spacer or spacing member 500 is illustrated. In some examples, it may be desirable to couple only a single tool to the tool support 48. In such examples, it may be desirable to use the spacer 500 with the tool and couple the spacer 500 to the tool support 48 in conjunction with the single tool. It should be understood that the spacer 500 is configured to cooperate with and be coupled to the tool support 48 with any of the tools 53, 53A, 54, 54A, 53′, 53A′, 54′, 54A′ disclosed herein. The illustrated example of the spacer 500 shown in FIGS. 14-16 is shown in combination with the tools 53′, 53A′, 54′, 54A′ illustrated in FIGS. 10-13, which is not intended to be limiting upon the present disclosure, but rather to demonstrate at least some of the principles of the present disclosure. As indicate above, the spacer 500 may be used with any of the tools disclosed herein and alternatives thereof.

The spacer 500 is configured to assist with proper alignment of the tool relative to the pipe P. More particularly, with additional reference to FIG. 1, the pipe machining apparatus 20 includes two tool supports 48 on opposite sides thereof. One of the tool supports 48 supports the desired tool 53, 53A, 54, 54A, 53′, 53A′, 54′, 54A′ and the spacer 500 to bevel a respective end of the pipe portions P1, P2 while the other tool support 48 supports the tool 52 configured to cut a groove 86 through the pipe P. In other words, tool 52 may be referred to as a parting tool that cuts all the way through the pipe P to separate the pipe P into two different portions P1, P2. The spacer 500 is configured to properly position the one of the tools 53, 53A, 54, 54A, 53′, 53A′, 54′, 54A′ relative to the groove 86, otherwise known as the parting line, where the pipe P is cut into two separate parts P1, P2. Positioning the one of the tools 53, 53A, 54, 54A, 53′, 53A′, 54′, 54A′ properly relative to the parting line in the pipe P ensures that the bevel cut by the one of the tools 53, 53A, 54, 54A, 53′, 53A′, 54′, 54A′ is properly cut into the pipe P with the proper configuration (e.g., size, length, shape, etc.) and at the proper location.

The spacer 500 is capable of having any thickness T and all of such possibilities are intended to be within the spirit and scope of the present disclosure. In one example, the spacer 500 has a thickness T of 0.25 inches. In another example, the spacer 500 has a thickness between about 0.1 inches to about 0.5 inches.

With particular reference to FIG. 14, in the illustrated example, the spacer 500 includes a pair of coupling apertures 506 configured to be interchangeably aligned with a pair of apertures 508 defined in each of the tools 53, 53A, 54, 54A, 53′, 53A′, 54′, 54A′. A pair of coupling members 510 are selectively insertable into aligned apertures 506, 508 to interchangeably couple the spacer 500 to a desired one of the tools. In other examples, the spacer 500 and tools may include a different number of apertures 506, 508 (including one aperture each or more than two apertures each) and, correspondingly, any number of coupling members 510 may be used to interchangeably couple the spacer 500 to the tools.

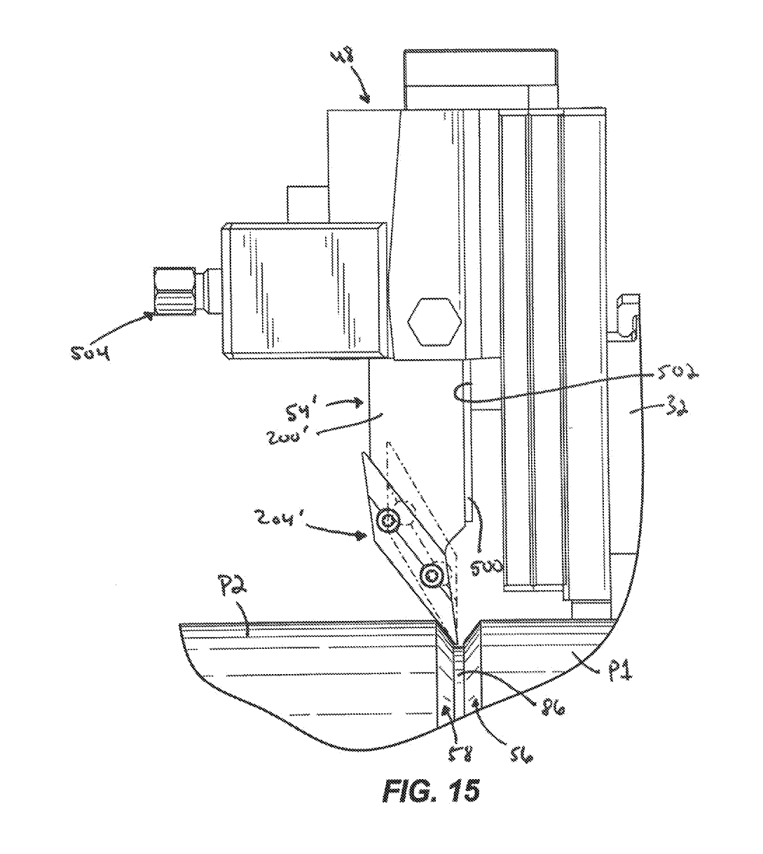

Referring now to FIG. 15, the spacer 500 is coupled to the tool support 48 with exemplary tool 54′. In this example, the spacer 500 is positioned between the tool 54′ and an end surface 502 of the tool support 48. The end surface 502 defines an end of a cavity configured to receive the tools. The tool 54′ and spacer 500 are secured in the tool support 48 by a coupling member 504. The exemplary tool 54′ illustrated in FIG. 15 with the spacer 500 is an outside tool configured to bevel end of pipe portion P2. Thus, in the illustrated example, the parting tool 52 is positioned to a right (as viewed in FIG. 15, could be different from different views) of the beveled end of pipe portion P2 and the spacer 500 is also positioned to a right of the tool 54′. It should be understood that the tools and the spacer 500 may have different configurations and cooperate in different manners to properly position the tools relative to the parting tool 52 and the parting groove 86, and all of such possibilities are intended to be within the spirit and scope of the present disclosure.

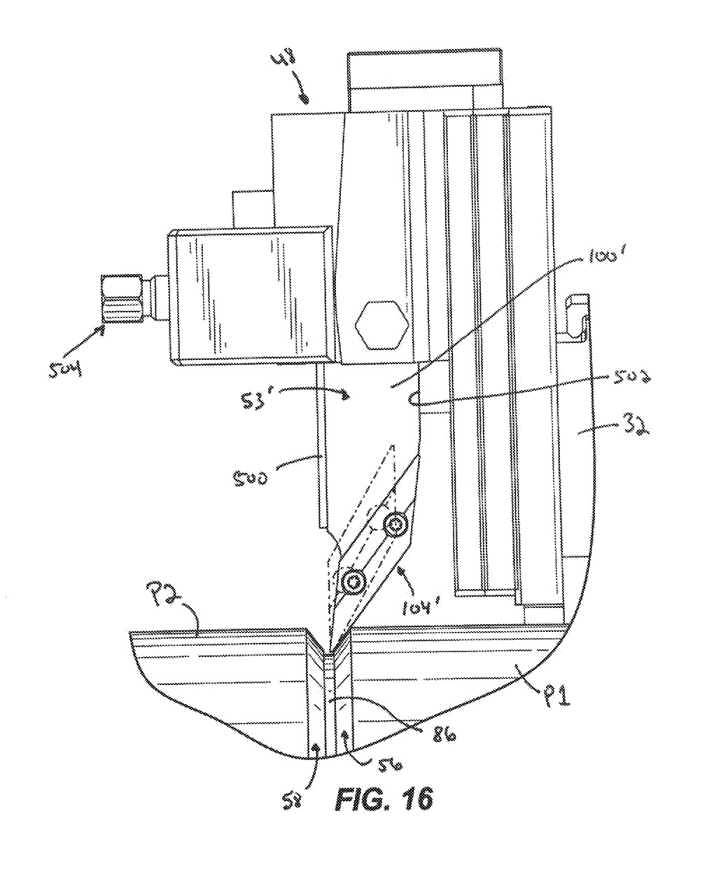

With reference to FIG. 16, the spacer 500 is coupled to the tool support 48 with exemplary tool 53′. In this example, the tool 53′ is positioned between the spacer 500 and the end surface 502 of the tool support 48. The tool 53′ and spacer 500 are secured in the tool support 48 by the coupling member 504. The exemplary tool 53′ illustrated in FIG. 16 with the spacer 500 is an inside tool configured to bevel end of pipe portion P1. Thus, in the illustrated example, the parting tool 52 is positioned to a left (as viewed in FIG. 16, could be different from different views) of the beveled end of pipe portion P1 and the spacer 500 is also positioned to a left of the tool 53′. It should be understood that the tools and the spacer 500 may have different configurations and cooperate in different manners to properly position the tools relative to the parting tool 52 and the parting groove 86, and all of such possibilities are intended to be within the spirit and scope of the present disclosure.

It should be understood that the use of any orientation or directional terms herein such as, for example, “top”, “bottom”, “front”, “rear”, “back”, “left”, “right”, “side”, etc., is not intended to imply only a single orientation of the item with which it is associated or to limit the present disclosure in any manner. The use of such orientation or directional terms is intended to assist with the understanding of principles disclosed herein and to correspond to the exemplary orientation illustrated in the drawings. For example, the pipe machining apparatus and cutting tools may be utilized in any orientation and use of such terms is intended to correspond to the exemplary orientation of the pipe machining apparatus and cutting tools illustrated in the drawings. The use of these terms in association with the pipe machining apparatus and cutting tools is not intended to limit the pipe machining apparatus and cutting tools to a single orientation or to limit the pipe machining apparatus and cutting tools in any manner.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, inventive subject matter lies in less than all features of a single disclosed embodiment.

While various embodiments of the disclosure have been described, it will be apparent to those of ordinary skill in the art that other embodiments and implementations are possible within the scope of the disclosure. Accordingly, the disclosure is not to be restricted except in light of the attached claims and their equivalents.

1. A pipe cutting assembly comprising:
a first base including a first projection and a first coupling aperture defined in the first projection;
a second base separate from the first base, wherein the second base includes a second projection and a second coupling aperture defined in the second projection; and
a cutting insert including a cutting edge and an insert aperture defined therein, wherein the cutting insert interchangeably couples to the first base and the second base, and wherein, with the cutting insert coupled to the first base, the first projection is at least partially positioned in the insert aperture, and wherein, with the cutting insert coupled to the second base, the second projection is at least partially positioned in the insert aperture.

2. The pipe cutting assembly of claim 1, wherein the insert aperture defines a first portion having a first configuration and a second portion having a second configuration different than the first configuration, wherein the first configuration is complementary to configurations of the first and second projections.

3. The pipe cutting assembly of claim 2, wherein the first projection and the second projection have a same configuration.

4. The pipe cutting assembly of claim 1, wherein, with the cutting insert coupled to the first base, the first coupling aperture aligns with the insert aperture, and wherein, with the cutting insert coupled to the second base, the second coupling aperture aligns with the insert aperture.

5. The pipe cutting assembly of claim 4, further comprising a coupling member configured to insert into the aligned first coupling aperture and insert aperture with the cutting insert coupled to the first base and configured to insert into the aligned second coupling aperture and insert aperture with the cutting insert coupled to the second base.

6. The pipe cutting assembly of claim 1, wherein the first projection is one of a plurality of first projections on the first base and the second projection is one of a plurality of second projections on the second base, and wherein the first coupling aperture is one of a plurality of first coupling apertures defined in the first base and the second coupling aperture is one of a plurality of second coupling apertures defined in the second base, and wherein one of the plurality of first coupling apertures is defined in each of the plurality of first projections and one of the plurality of second coupling apertures is defined in each of the plurality of second projections.

7. The pipe cutting assembly of claim 6, wherein the insert aperture is one of a plurality of insert apertures defined in the cutting insert, and wherein, with the cutting insert coupled to the first base, one of the plurality of first projections is at least partially positioned in each of the plurality of insert apertures, and wherein, with the cutting insert coupled to the second base, one of the plurality of second projections is at least partially positioned in each of the plurality of insert apertures.

8. The pipe cutting assembly of claim 7, further comprising a plurality of coupling members, wherein each of the plurality of coupling members is configured to insert into an aligned set of one of the first coupling apertures and one of the insert apertures with the cutting insert coupled to the first base and configured to insert into an aligned set of one of the second coupling apertures and one of the insert apertures with the cutting insert coupled to the second base.

9. A pipe machining apparatus comprising:
a frame;
a tool carrier moveably coupled to the frame;
a tool support coupled to and moveable with the tool carrier;
a first base including a first projection and a first coupling aperture defined in the first projection;
a second base separate from the first base, wherein the second base includes a second projection and a second coupling aperture defined in the second projection, wherein the tool support is configured to interchangeably support the first base and the second base; and
a cutting insert including a cutting edge and an insert aperture defined therein, wherein the cutting insert interchangeably couples to the first base and the second base, and wherein, with the cutting insert coupled to the first base, the first projection is at least partially positioned in the insert aperture, and wherein, with the cutting insert coupled to the second base, the second projection is at least partially positioned in the insert aperture.

10. The pipe machining apparatus of claim 9, wherein the insert aperture defines a first portion having a first configuration and a second portion having a second configuration different than the first configuration, wherein the first configuration is complementary to configurations of the first and second projections.

11. The pipe machining apparatus of claim 10, wherein the first projection and the second projection have a same configuration.

12. The pipe machining apparatus of claim 9, wherein, with the cutting insert coupled to the first base, the first coupling aperture aligns with the insert aperture, and wherein, with the cutting insert coupled to the second base, the second coupling aperture aligns with the insert aperture.

13. The pipe machining apparatus of claim 12, further comprising a coupling member configured to insert into the aligned first coupling aperture and insert aperture with the cutting insert coupled to the first base and configured to insert into the aligned second coupling aperture and insert aperture with the cutting insert coupled to the second base.

14. The pipe machining apparatus of claim 9, wherein the first projection is one of a plurality of first projections on the first base and the second projection is one of a plurality of second projections on the second base, and wherein the first coupling aperture is one of a plurality of first coupling apertures defined in the first base and the second coupling aperture is one of a plurality of second coupling apertures defined in the second base, and wherein one of the plurality of first coupling apertures is defined in each of the plurality of first projections and one of the plurality of second coupling apertures is defined in each of the plurality of second projections.

15. The pipe machining apparatus of claim 14, wherein the insert aperture is one of a plurality of insert apertures defined in the cutting insert, and wherein, with the cutting insert coupled to the first base, one of the plurality of first projections is at least partially positioned in each of the plurality of insert apertures, and wherein, with the cutting insert coupled to the second base, one of the plurality of second projections is at least partially positioned in each of the plurality of insert apertures.

16. The pipe machining apparatus of claim 15, further comprising a plurality of coupling members, wherein each of the plurality of coupling members is configured to insert into an aligned set of one of the first coupling apertures and one of the insert apertures with the cutting insert coupled to the first base and configured to insert into an aligned set of one of the second coupling apertures and one of the insert apertures with the cutting insert coupled to the second base.
